(19) United States
(12) Patent Application Publication
(10) Pub. No.: US 2022/0182465 A1
(43) Pub. Date: Jun. 9, 2022

(54) NETWORK MANAGEMENT SERVER, NETWORK DEVICE, AND ERRONEOUS CONNECTION DETECTION PROGRAM

(71) Applicant: ALAXALA Networks Corporation, Kanagawa (JP)

(72) Inventors: Hirotaka SUNAMI, Kawasaki-shi (JP); Tomomi SUZUKI, Kawasaki-shi (JP)

(21) Appl. No.: 17/512,727

(22) Filed: Oct. 28, 2021

(30) Foreign Application Priority Data
Dec. 8, 2020 (JP) 2020-203514
Aug. 27, 2021 (JP) 2021-138536

(51) Int. Cl. H04L 29/08; H04L 29/06

(52) U.S. Cl. CPC H04L 67/34; H04L 67/2852; H04L 67/42

(57) ABSTRACT

In a case where reconnection of a cable is performed by replacement of a network device, an erroneous connection detection unit of a network management server compares opposing identification information of current value information and opposing identification information of expected value information, compares group identification information before the replacement of the network device and group identification information after the replacement of the network device, with reference to port configuration information, and determines the presence or absence of erroneous connection of the cable, on the basis of a result of the comparison.

### CROSS-REFERENCE TO RELATED APPLICATION

The present application claims priority from Japanese application JP 2020-203514 filed on Dec. 8, 2020, and JP 2021-138536 filed Aug. 27, 2021, the contents of which are hereby incorporated by reference into this application.

### BACKGROUND OF THE INVENTION

### 1. Field of the Invention

The present invention relates to a network management server, a network device, and an erroneous connection detection program.

### 2. Description of the Related Art

Recently, a network system has been widespread in accordance with a change in social situations or lifestyles, and a network device has been installed everywhere. However, human resources for operating and managing the network device are not sufficient and staffs for local response are also limited, and thus, non-expertness or efficiency has been required to operate and manage a plurality of network devices.

In an operation of replacing a network device, which is one of operation and management, it is necessary to connect a plurality of cables connected to the device to the same port as the previously connected port, after the replacement of the device. In a case where erroneous connection occurs in this operation, expert troubleshooting is required from grasping a communication state to specifying an erroneous connection spot by detecting the erroneous connection, and it takes time for restoration.

As a system of detecting erroneous connection of a cable with respect to a port of a network device, a method is described in JP 2019-176393 A in which a media access control (MAC) address received by a link layer discovery protocol (LLDP) or operation administration and maintenance (CAM) is set as an opposing end point ID of an opposing side, an expected value of the opposing end point ID set and retained in advance and a current value of the opposing end point ID received from the opposing side after the reconnection of a cable are compared, and erroneous connection is detected in accordance with coincidence or non-coincidence between the values.

In addition, a method is described in JP 2008-124791 A in which a MAC address of a forwarding database (FDB) is set as an opposing end point ID, and the opposing end point ID received in advance from an opposing side is used as an expected value.

In such methods, in a layer 2 switch that is a network device, for example, even in a case where there is no influence on communication or the like even at the time of performing connection to any of a plurality of ports that are ports to which a terminal is connected, connection to a port that is different from the previously connected port is detected as erroneous connection.

### SUMMARY OF THE INVENTION

An object of the invention is not to treat connection to a port that is different from the previously connected port as erroneous connection in a case where there is no influence in communication or the like even at the time of performing connection to any of plurality of ports, in a replacing operation of a network device.

A network management server of one aspect of the invention is a network management server, including: an erroneous connection detection unit connected to a network device including a plurality of ports connected to a plurality of opposing devices by cables through a network, in which the erroneous connection detection unit stores expected value information in which the plurality of ports and opposing identification information of the plurality of opposing devices are associated with each other in a state before replacement of the network device, current value information in which the plurality of ports and the opposing identification information of the plurality of opposing devices are associated with each other in a state after the replacement of the network device, and port configuration information in which the plurality of ports and group identification information grouped in accordance with a configuration of the port are associated with each other, and when reconnection of the cable is performed by the replacement of the network device, the erroneous connection detection unit compares the opposing identification information of the current value information and the opposing identification information of the expected value information, compares the group identification information before the replacement of the network device and the group identification information after the replacement of the network device, with reference to the port configuration information, and determines the presence or absence of erroneous connection of the cable, on the basis of a result of the comparison.

A network device of one aspect of the invention is a network device including a plurality of ports connected to a plurality of opposing devices by cables, the network device including: an erroneous connection detection unit; and a removable auxiliary storage medium, in which the auxiliary storage medium stores expected value information in which the plurality of ports and opposing identification information of the plurality of opposing devices are associated with each other in a state before replacement of the network device, the erroneous connection detection unit stores current value information in which the plurality of ports and the opposing identification information of the plurality of opposing devices are associated with each other in a state after the replacement of the network device, and port configuration information in which the ports and group identification information grouped in accordance with a configuration of the port are associated with each other, and when reconnection of the cable is performed by the replacement of the network device, the auxiliary storage medium is replaced to the network device after the replacement from the network device before the replacement, and the erroneous connection detection unit compares the opposing identification information of the current value information and the opposing identification information of the expected value information stored in the auxiliary storage medium, compares the group identification information before the replacement of the network device and the group identification information after the replacement of the network device, with reference to the port configuration information, and determines the presence or absence of erroneous connection of the cable, on the basis of a result of the comparison.

An erroneous connection detection program of one aspect of the invention is an erroneous connection detection program stored in a network management server connected to a network device including a plurality of ports connected to a plurality of opposing devices by cables through a network, the erroneous connection detection program configured to allow a computer: to execute processing of storing expected value information in which the plurality of ports and opposing identification information of the plurality of opposing devices are associated with each other in a state before replacement of the network device, current value information in which the plurality of ports and the opposing identification information of the plurality of opposing devices are associated with each other in a state after the replacement of the network device, and port configuration information in which the plurality of ports and group identification information grouped in accordance with a configuration of the port are associated with each other; and when reconnection of the cable is performed by the replacement of the network device, to execute processing of comparing the opposing identification information of the current value information and the opposing identification information of the expected value information; processing of comparing the group identification information before the replacement of the network device and the group identification information after the replacement of the network device, with reference to the port configuration information; and processing of determining the presence or absence of erroneous connection of the cable, on the basis of a result of the comparison.

According to one aspect of the invention, in a replacing operation of a network device, in a case where there is no influence on communication or the like even at the time of performing connection to any of a plurality of ports, connection to a port that is different from the previously connected port is not treated as erroneous connection.

### BRIEF DESCRIPTION OF THE DRAWINGS

FIG. 1 is a diagram illustrating a configuration of a network;

FIG. 2 is a diagram illustrating a configuration of a network after reconnection;

FIG. 3 is a diagram illustrating a configuration of a network management server in Example 1;

FIG. 4 is a diagram illustrating a configuration of a layer 2 switch in Example 1;

FIG. 5 is a diagram illustrating an expected value of LLDP information;

FIG. 6 is a diagram illustrating an expected value of FDB information;

FIG. 7 is a diagram illustrating a current value of LLDP information;

FIG. 8 is a diagram illustrating a current value of FDB information;

FIG. 9 is a diagram illustrating LLDP information for comparison;

FIG. 10 is a diagram illustrating FDB information for comparison;

FIG. 11 is a diagram illustrating port configuration information;

FIG. 12 is a flowchart illustrating an overall operation of erroneous connection detection in Example 1;

FIG. 13 is a flowchart illustrating a collecting operation of an expected value;

FIG. 14 is a flowchart illustrating a collecting operation of current value and an opposing ID comparing operation;

FIG. 15 is a flowchart illustrating a collecting operation of a port configuration and a grouping comparing operation;

FIG. 16 is a flowchart illustrating a final comparing operation;

FIG. 17 is a diagram illustrating an example of a user I/F screen;

FIG. 18 is a diagram illustrating a configuration of a layer 2 switch in Example 2;

FIG. 19 is a diagram illustrating an example of LLDP information in a layer 2 switch;

FIG. 20 is a diagram illustrating an example FDB information in a layer 2 switch;

FIG. 21 is a flowchart illustrating an overall operation of erroneous connection detection in Example 2;

FIG. 22 is a diagram illustrating a configuration of a network in Example 3;

FIG. 23 is a diagram illustrating a configuration of a network after reconnection in Example 3;

FIG. 24 is a diagram illustrating an expected value of FDB information in Example 3;

FIG. 25 is a diagram illustrating a current value of FDB information in Example 3;

FIG. 26 is a diagram illustrating FDB information for comparison in Example 3;

FIG. 27 is a flowchart illustrating an overall operation of erroneous connection detection in Example 3;

FIG. 28 is a flowchart illustrating a comparing operation of a plurality of candidates in Example 3; and

FIG. 29 is a diagram illustrating an example of a user I/F screen in Example 3.

### DETAILED DESCRIPTION OF THE PREFERRED EMBODIMENTS

Hereinafter, Examples will be described by using the drawings.

### Example 1

In Example 1, an example of detecting erroneous connection that causes actual damage by affecting communication while allowing a connection error with respect to ports with the same port configuration, which does not affect the communication, when the reconnection of a cable is performed by the replacement or the like of a layer 2 switch, with a configuration in which an erroneous connection detection unit is provided in a network management server, will be described.

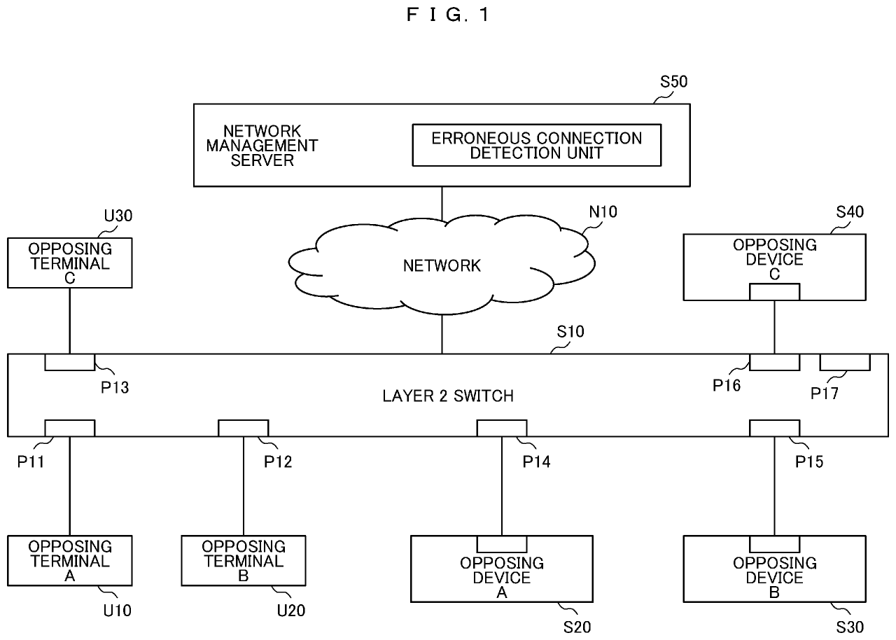

FIG. 1 is an explanatory diagram illustrating a configuration example of a network system in Example 1 of the invention.

In the network system of FIG. 1, a network management server S50 is connected to a layer 2 switch S10, which is a target for detecting erroneous connection, through a network N10. The layer 2 switch S10 includes ports P11 to P17. The port P11 is connected to an opposing terminal A(U10), the port P12 is connected to an opposing terminal B(U20), the port P13 is connected to an opposing terminal C(U30), the port P14 is connected to an opposing device A(S20), the port P15 is connected to an opposing device B(S30), and the port P16 is connected to an opposing device C(S40) by cables such as a copper wire or an optical fiber, respectively. Note that, nothing is connected to the port P17. Here, the opposing device is a layer 2 switch different from the layer 2 switch S10, or a layer 3 switch.

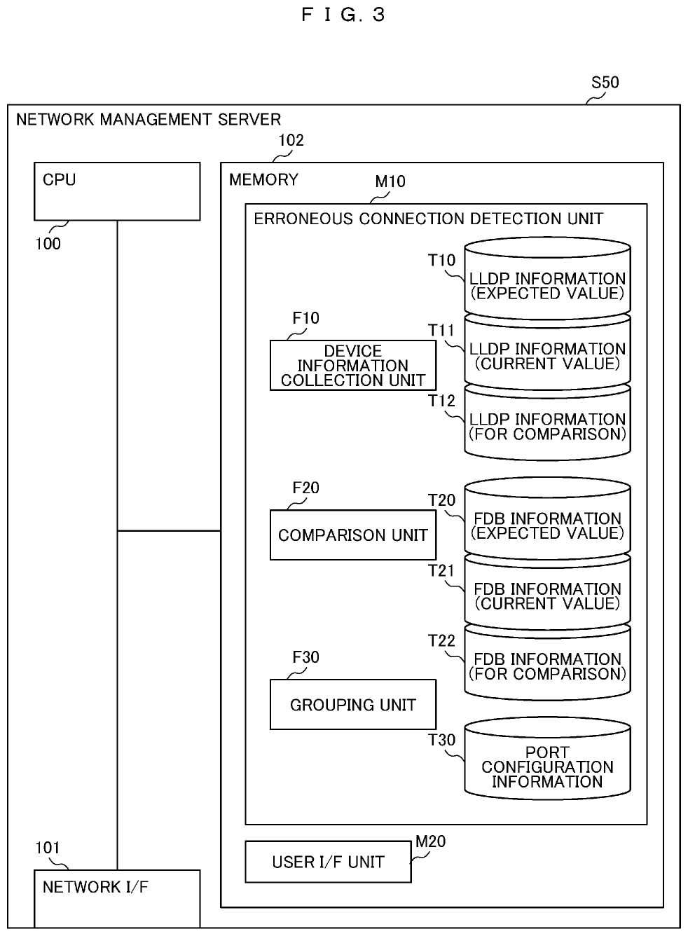

FIG. 3 is an explanatory diagram illustrating a configuration example of the network management server S50.

The network management server S50 includes a CPU 100, a network I/F 101, and a memory 102, and includes an erroneous connection detection unit M10 and a user I/F unit M20 in the memory 102. Further, the erroneous connection detection unit M10 includes a processing unit of a device information collection unit F10, a comparison unit F20, and a grouping unit F30, and includes a table of LLDP information (an expected value) T10, LLDP information (a current value) T11, LLDP information (a comparison value) T12, FDB information (an expected value) T20, FDB information (a current value) T21, FDB information (a comparison value) T22, and port configuration information T30. Note that, in this example, all of the erroneous connection detection unit M10, the device information collection unit F10, the comparison unit F20, the grouping unit F30, and the user I/F unit M20 are a program that is executed by the CPU 100.

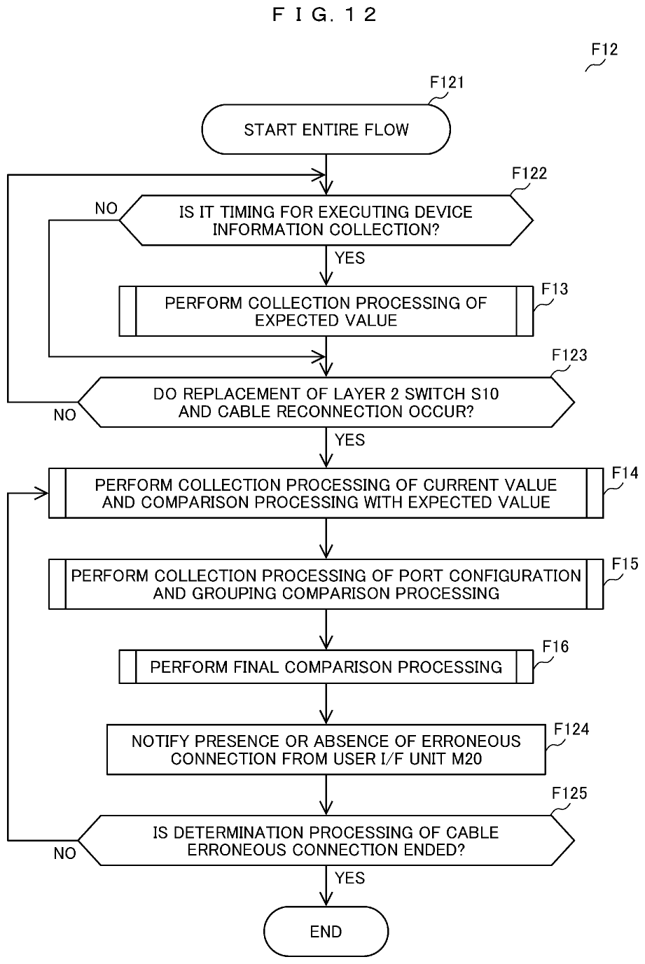

In each state before and after the replacement of the layer 2 switch S10, the erroneous connection detection unit M10 collects information of a cable connection state of each of the ports (P11 to P17) of the layer 2 switch S10 or a connection destination device from the layer 2 switch S10, and determines erroneous connection of the cable by comparing the information. The detailed operation thereof, and the content and a using method of each of the tables will be described below by using flowcharts in FIG. 12 and the subsequent drawings.

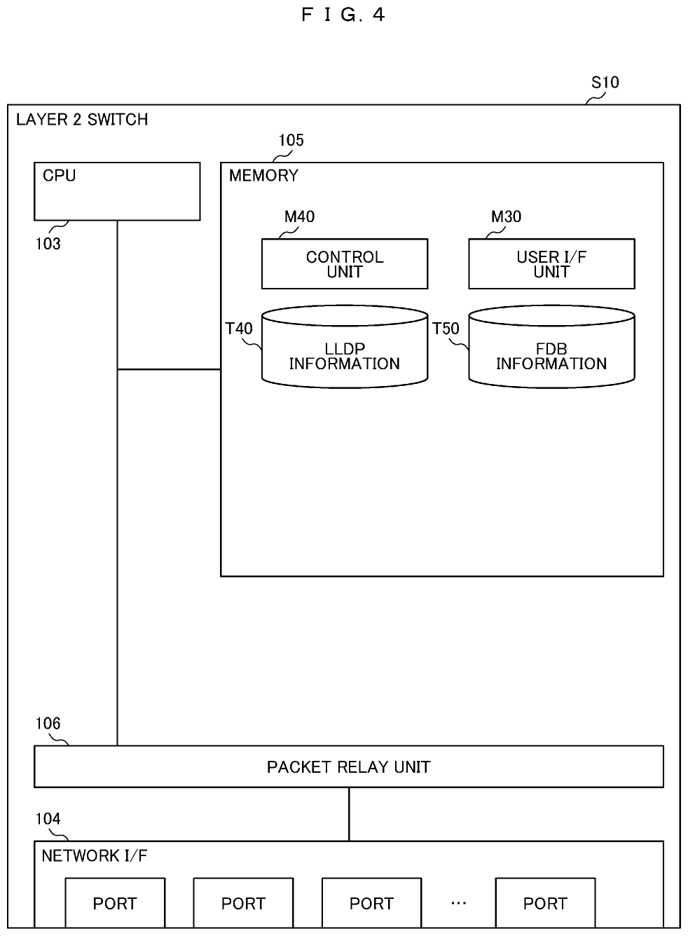

FIG. 4 is an explanatory diagram illustrating an example of a general configuration of the layer 2 switch S10.

The layer 2 switch S10 in FIG. 4 includes a CPU 103, a network I/F 104 including a plurality of ports, a memory 105, and a packet relay unit 106. In the memory 105, a control unit M40, a user I/F unit M30, and LLDP information T40 and FDB information T50, which are tables, are provided. Both of the control unit M40 and the user I/F unit M30 are a program that is executed by the CPU 103.

In the layer 2 switch S10, in a case where a packet is received by any port of the network I/F 104, the packet relay unit 106 determines another port of the network I/F 104 to be a transmission destination of the packet, on the basis of a destination MAC address of the packet and the content of the FDB information T50, and the packet is transmitted from the port. Alternatively, in a case where the destination MAC address of the packet is a MAC address of the layer 2 switch S10 itself, the packet is transmitted to the CPU 103 by being interpreted as a packet for the layer 2 switch S10. Further, as necessary, a combination of a transmission source MAC address of the packet and an identifier of a port in which the packet is received is registered in the FDB information T50 (MAC address learning).

FIG. 20 is a diagram illustrating an example of the FDB information T50. A plurality of entries of a combination of identification information (a port C500) of the port and the MAC address (an opposing ID (a MAC address) C501) can be stored, and information indicating which terminal with which MAC address of which port is connected is retained.

In a case where the packet for the layer 2 switch S10 is received from the packet relay unit 106, the control unit M40 executes suitable processing, in accordance with the content of the packet. For example, in a case where the packet is a packet according to a protocol referred to as LLDP, identification information of an opposing device (another layer 2 switch or the like) included in the packet is stored in the LLDP information T40 together with the identification information of the port in which the packet is received.

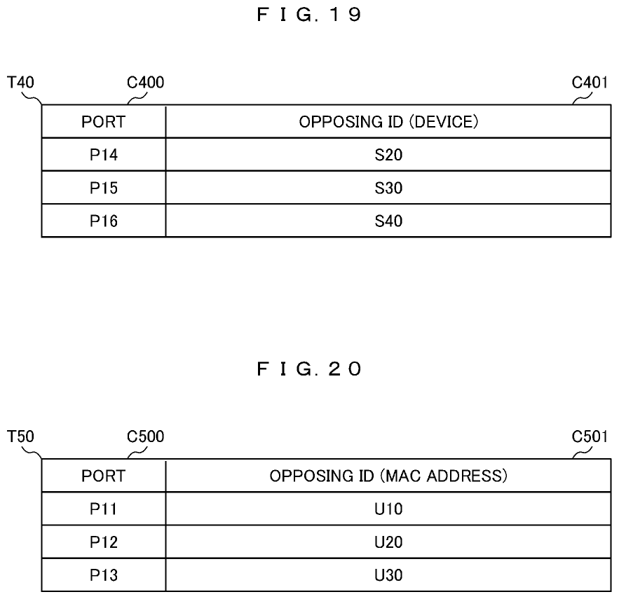

FIG. 19 is a diagram illustrating an example of the LLDP information T40.

A plurality of entries of a combination of the identification information (a port C400) of the port and identification information (an opposing ID (a device) C401) included in an LLDP packet can be stored, and information indicating which device with which identification information of which port, such as the layer 2 switch, is connected is retained.

In a case where the packet received from the packet relay unit 106 is an information collection instruction command from the network management server S50, the control unit M40 performs processing of transmitting the content of the LLDP information T40 or the FDB information T50 to the network management server S50, as a response, in accordance with the content of the instruction. As a protocol for such an instruction and a response, for example, a simple network management protocol (SNMP) or the like can be used.

The user I/F unit M30 provides a user I/F function for an administrator to perform various setting processing or a state check with respect to the layer 2 switch S10.

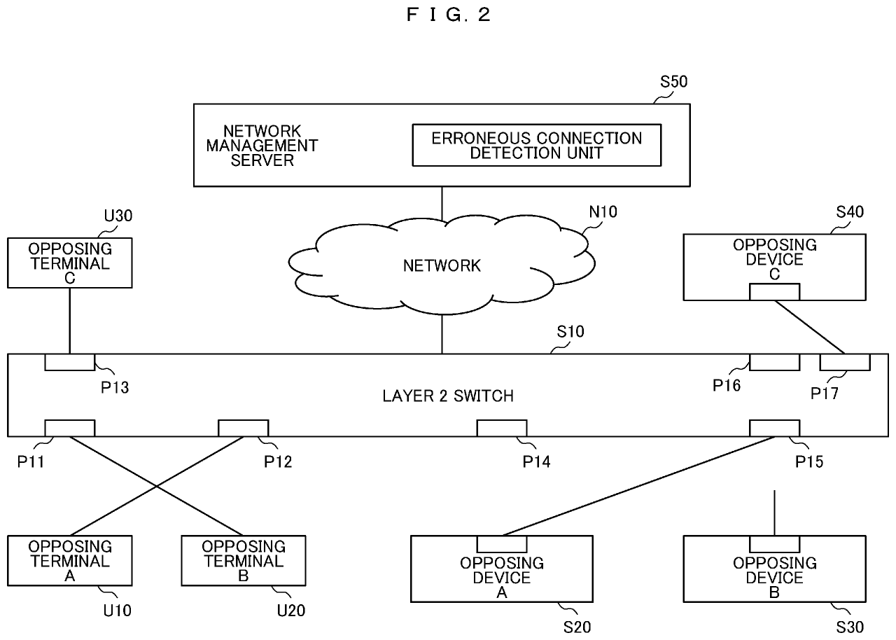

FIG. 2 is an explanatory diagram illustrating a configuration example of a network after the replacement of the layer 2 switch S10. Note that, the layer 2 switch S10 is replaced to a physically different switch by the replacement, but the physically different switch has the same configuration as that of the layer 2 switch S10 before the replacement, and the same reference numerals are applied to the same constituents.

In the configuration of the network in FIG. 2, the replacement of the layer 2 switch S10 occurs in the configuration of FIG. 1, the port P11 is connected to the opposing terminal B(U20), the port P12 is connected to the opposing terminal A(U10), the port P13 is connected to the opposing terminal C(U30), the port P15 is connected to the opposing device A(S20), and the port P17 is connected to the opposing device C(S40), by a cable reconnection operation after the replacement. Note that, nothing is connected to the port P14 and the port P16.

As described above, an operation example of detecting the occurrence of the erroneous connection will be described below by using a case where the erroneous connection as illustrated in FIG. 2 occurs due to a reconnection operation after the replacement of the device from the system configuration in FIG. 1, as an example.

FIG. 12 is a flowchart illustrating the overall operation of erroneous connection detection of the erroneous connection detection unit M10.

The erroneous connection detection unit F10 determines whether or not it is a timing for executing device information collection processing (step F122), and in a case where it is the timing for executing the device information collection processing, collection processing step F13 of the expected value is executed by calling up the device information collection unit F10, and then, the process proceeds to step F123, and in a case where it is not the timing, the process directly proceeds to step F123. The timing for executing the device information collection processing, for example, may be a timing for periodically executing the device information collection processing at a predetermined time interval, or may be a timing for the administrator to receive a start command of the device information collection processing through the user I/F unit M20.

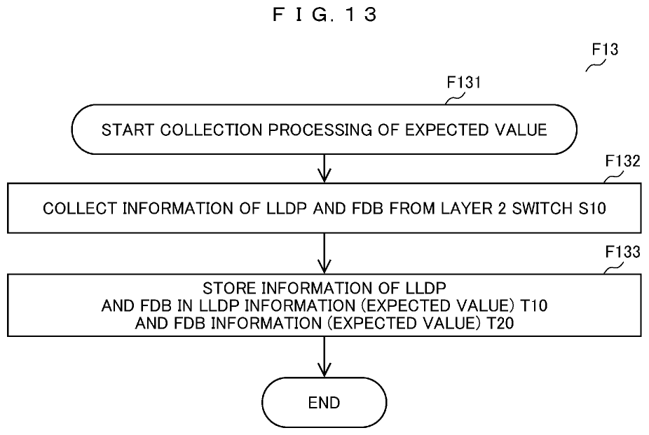

FIG. 13 is a flowchart illustrating the details of the collection processing (step F13) of the expected value. The processing of step F13 is processing to be executed by the device information collection unit F10 that is called by the erroneous connection detection unit M10.

The device information collection unit F10 collects the contents of the LLDP information T40 and the FDB information T50, for example, by using a protocol such as SNMP, from the layer 2 switch S10 (step F132). Then, the collected content of the LLDP information T40 is stored in the LLDP information (the expected value) T10, and the connected content of the FDB information T50 is stored in the FDB information (the expected value) T20, respectively (step F133).

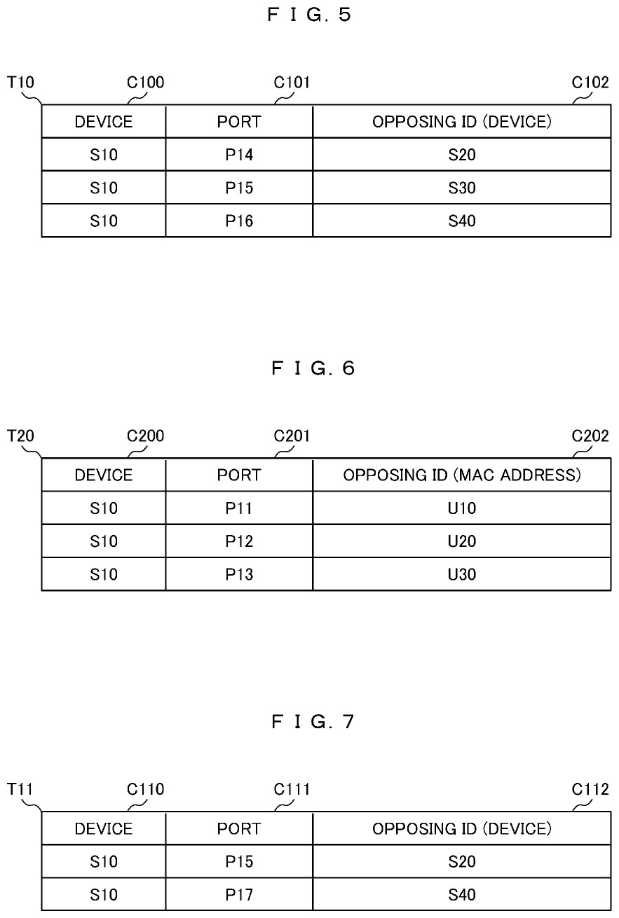

FIG. 5 and FIG. 6 are diagrams illustrating the contents of the LLDP information (the expected value) T10 and the FDB information (the expected value) T20. The LLDP information (the expected value) T10 includes a plurality of entries retaining a combination of a device C100, a port C101, and an opposing ID (a device) C102. The FDB information (the expected value) T20 includes a plurality of entries retaining a combination a device C200, a port C201, and an opposing ID (a MAC address) C202.

In step F132, the device information collection unit F10 stores the content of the LLDP information T40 that is collected from the layer 2 switch S10 in the port C101 and the opposing ID (the device) C102, which are fields with the same name of the LLDP information (the expected value) T10, and stores an identifier (for example, “S10”) indicating that such information is collected from the layer 2 switch S10 in the field of the device C100. The device information collection unit F10 also stores the collected value of the FDB information T50 in a field with the same name corresponding to the FDB information (the expected value) T20, and stores an identifier indicating that such information is collected from the layer 2 switch S10 in a field of the device C200.

Note that, the information stored in the LLDP information (the expected value) T10 and the FDB information (the expected value) T20 is used as information indicating the original connection state to be expected at the time of performing the replacement of the layer 2 switch S10 and the reconnection of the cable, and thus, is referred to as the “expected value”.

Returning to the processing of FIG. 12, the erroneous connection detection unit M10 then determines whether or not the replacement of the layer 2 switch S10 and the subsequent reconnection of the cable occur (step F123). The erroneous connection detection unit M10, for example, recognizes that the replacement of the layer 2 switch S10 and the reconnection of the cable are performed by receiving a notification based on a protocol such as SNMP, which is transmitted when the layer 2 switch S10 after the replacement is activated, or by the user I/F unit M20 receiving a command indicating that the replacement of the layer 2 switch S10 is performed from the administrator.

In a case where the replacement of the layer 2 switch S10 and the reconnection of the cable occur, the erroneous connection detection unit M10 start processing of determining the erroneous connection, subsequent to step F14, and in a case where the replacement of the layer 2 switch S10 and the reconnection of the cable do not occur, the process returns to the processing of step F122. That is, the erroneous connection detection unit M10 repeatedly executes the collection of the latest LLDP information and FDB information from the layer 2 switch S10 at a predetermined timing until the replacement of the layer 2 switch S10 and the reconnection of the cable occur, and in a case where the replacement of the layer 2 switch S10 and the reconnection of the cable occur, the erroneous connection detection unit M10 is operated to start processing of determining whether or not the erroneous connection of the cable occurs.

In a case where it is determined that the replacement of the layer 2 switch S10 and the reconnection of the cable are performed in step F123, the erroneous connection detection unit M10 sequentially executes processing (step F14) of collecting the current value of the device information after the reconnection from the layer 2 switch S10 to be compared with the expected value collected in step F13, processing (step F15) of collecting the information of the port configuration from the layer 2 switch S10 to be compared by grouping, and final comparison processing (step F16) of determining the presence or absence of the final erroneous connection, as the processing of determining the erroneous connection. Hereinafter, the details of such processing will be described.

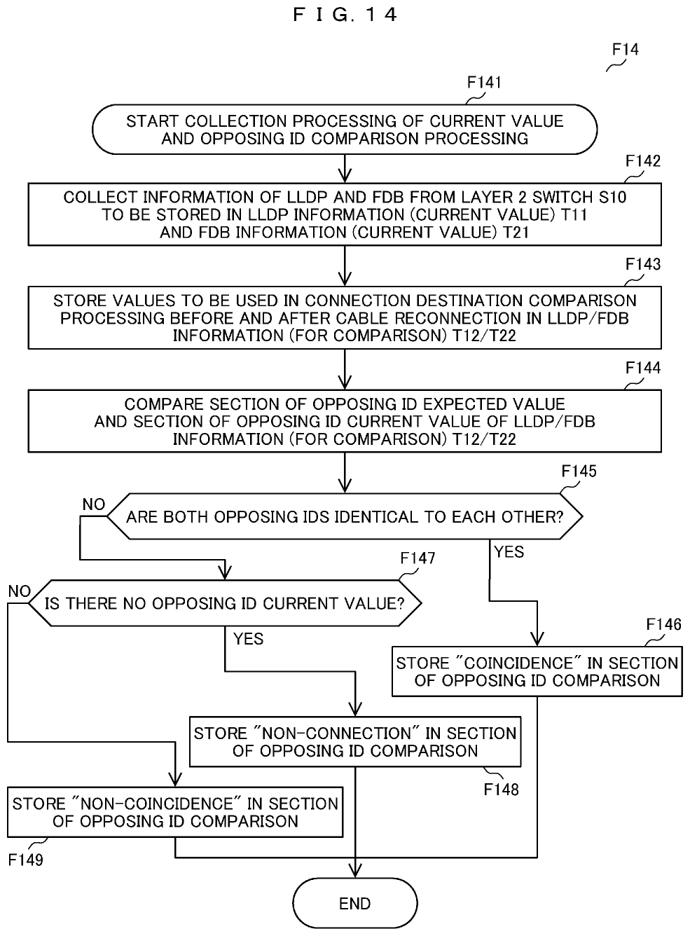

FIG. 14 is a flowchart illustrating the details of the processing (step F14) of collecting the current value of the device information after the reconnection from the layer 2 switch S10 to be compared with the expected value.

After the processing is started, the device information collection unit F10 called from the erroneous connection detection unit M10 collects the contents of the LLDP information T40 and the FDB information T50 from the layer 2 switch S10, for example, by using a protocol such as SNMP, and stores the collected content of the LLDP information T40 in the LLDP information (the current value) T11, and stores the collected content of the FDB information T50 in the FDB information (the current value) T21, respectively (step F142).

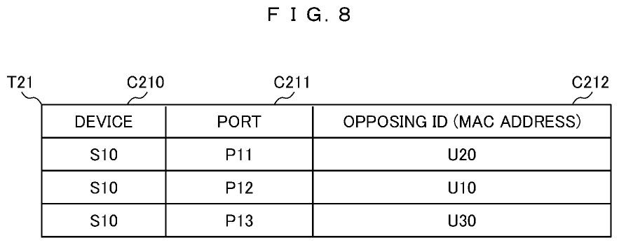

FIG. 7 and FIG. 8 are diagrams illustrating the contents of the LLDP information (the current value) T11 and the FDB information (the current value) T21. Each of such tables has the same structure as that of the LLDP information (the expected value) T10 and the FDB information (the expected value) T20. The processing of the device information collection unit F10 in step 142 is the same as the processing of the device information collection unit F10, illustrated in FIG. 13, except that a storage destination table of the acquired information includes the LLDP information (the current value) T11 and the FDB information (the current value) T21, and the detailed description will be omitted.

Note that, in the following description, the same processing is performed with respect to the LLDP information and the FDB information, and thus, in order to avoid the repeated description, the LLDP information and the FDB information may be collectively noted as LLDP/FDB information. In addition, similarly, for a table name, for example, a plurality of tables may be collectively noted as “LLDP/FDB information (a current value) T11/T21”.

Next, the comparison unit F20 called from the erroneous connection detection unit M10 executes the processing subsequent to step F143.

First, the comparison unit F20 stores values to be used in connection destination comparison processing before and after the reconnection of the cable in the LLDP/FDB information (for comparison) T12/T22 (step F143). Specifically, for each of the entries of the LLDP information (the expected value) T10, the values of the device C100, the port C101, and the opposing ID (the device) C102 are stored in a device C120, a port C121, and an opposing ID expected value C122 of the LLDP information (for comparison) T12, respectively. Further, for each of the entries of the LLDP information (the current value) T11, an opposing ID (a device) C112 is stored in an opposing ID current value C123 of an entry having the values of the same device and port of the LLDP information (for comparison) T12. In addition, as with the LLDP information (for comparison) T12, the contents of the FDB information (the expected value) T20 and the FDB information (the current value) T21 are stored in the FDB information (for comparison) T22.

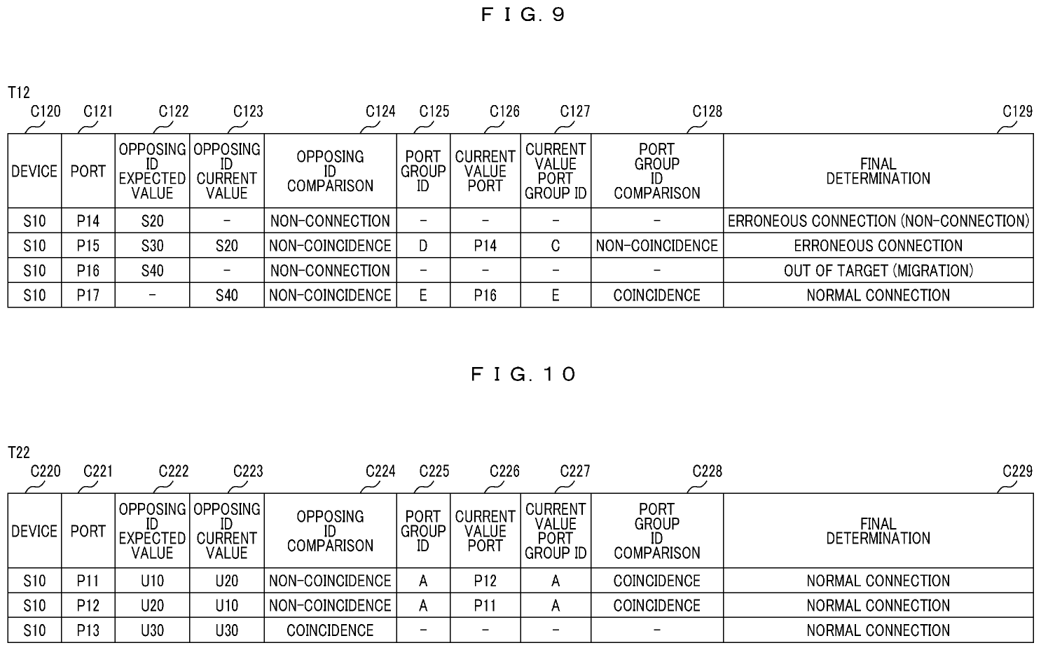

FIG. 9 and FIG. 10 are diagrams illustrating the content of the LLDP information (the expected value) T12 and the FDB information (for comparison) T22, respectively. Such tables include a plurality of entries retaining information for determining the presence or absence of a port of the network I/F 104, of which a connection destination is changed before and after the reconnection of the cable, in the layer 2 switch S10. Note that, in the LLDP/FDB information (the expected value) T12/T22, a field in which there is no information to be stored in step F143 is noted as “-”.

Next, the comparison unit F20 compares the values of the opposing ID expected value C122/C222 and the opposing ID current value C123/C223 for each of the entries of the LLDP/FDB information (for comparison) T12/T22 (step F144). The fact that the values of the opposing ID expected value C122/C222 and the opposing ID current value C123/C223 are identical to each other indicates the fact that devices to be connected to a port of a device indicated by the entry, before and after the reconnection of the cable.

Note that, an opposing ID to be a comparison target of a device that is a connection destination includes two types of opposing IDs of an opposing ID that is included in the LLDP information (an identifier of the device) and an device that is included in the FDB information (a MAC address of the device), and in the comparison processing, the LLDP information is preferentially used, and the FDB information is used in a port to which a device not corresponding to LLDP is connected (that is, a port not including the LLDP information).

As the result of the comparison, in a case where the opposing ID expected value C122/C222 and the opposing ID current value C123/C223 are identical to each other (YES of step F145), “coincidence” is stored in opposing ID comparison C124/C224 of the of the LLDP/FDB information (for comparison) T12/T22 (step F146), and the collection processing of the current value and the opposing ID comparison processing F14 are ended.

In step F145, in a case where the opposing ID expected value C122/C222 and the opposing ID current value C123/C223 are not identical to each other (NO of step F145), it is further determined whether or not the value of the opposing ID current value C123/C223 of the LLDP/FDB information (for comparison) T12/T22 is stored (step F147), and in a case where there is no value (“-” is noted), “non-connection” is stored in the opposing ID comparison C124/C224 of the LLDP/FDB information (for comparison) T12/T22, and the collection processing of the current value and the opposing ID comparison processing F14 are ended (step F148), and in a case where there is the value, “non-coincidence” is stored in the opposing ID comparison C124/C224 of the LLDP/FDB information (for comparison) T12/T22, and the collection processing of the current value and the opposing ID comparison processing F14 are ended (step F149).

Note that, the processing of step F144 to step F149 is executed with respect to all of the entries of the LLDP/FDB information (for comparison) T12/T22.

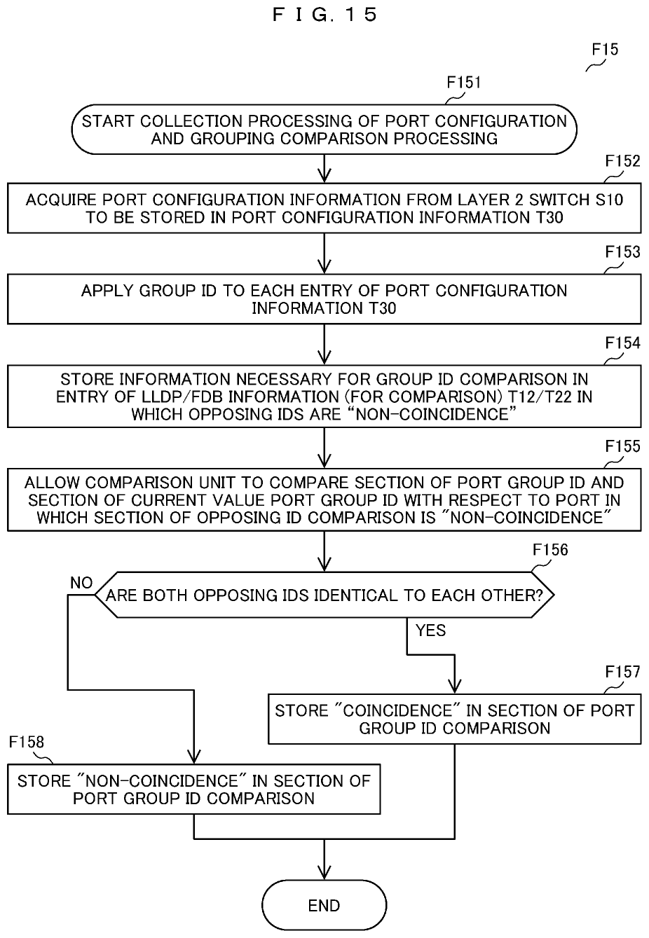

FIG. 15 is a flowchart illustrating the details of a collecting operation of the port configuration and grouping comparison processing (step F15).

After the processing is started, in processing F152, the device information collection unit F10 called from the erroneous connection detection unit M10, for example, collects configuration information of the port from the layer 2 switch S10 by using a protocol such as SNMP, and stores the configuration information in the port configuration information T30. Note that, Example 1 is premised on the fact that the port configuration of the layer 2 switch S10 is the same before and after the replacement.

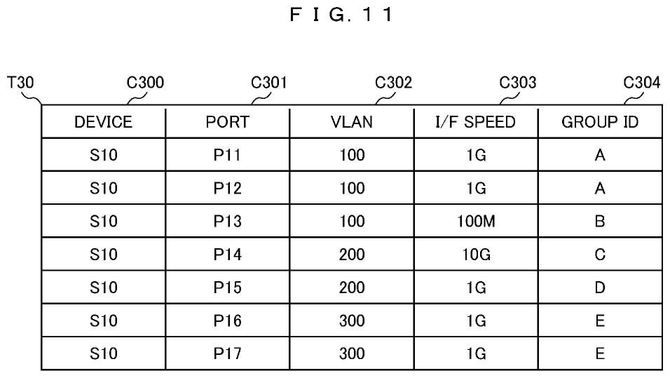

FIG. 11 is a diagram illustrating the content of the port configuration information T30. The port configuration information T30 is a table storing a setting state of each of the ports of the network I/F 104 that is acquired from the layer 2 switch S10, and includes a plurality of entries including each field of VLAN C302 storing a VLAN identifier to which the port belongs, an I/F speed C303 indicating a line speed of the port, and a port group ID C304 storing an ID applied to the port in step F153, for each of the ports.

Next, the grouping unit F30 called from the erroneous connection detection unit M10 applies a group ID to each of the ports C301 of the port configuration information T30 such that ports having the same VLAN C302 and the same I/F speed C303 are in the same group, and stores the group ID in the group ID C304. In the description using values noted in FIG. 11 as an example, for example, both of the ports P11 and P12 belong to the same VLAN of “100” and have the same I/F speed of “1 Gbps”, and thus, the group ID of “A” is applied to both of the ports P11 and P12 to be in the same group.

Next, for each of the entries of the LLDP/FDB information (for comparison) T12/T22, the comparison unit F20 called from the erroneous connection detection unit M10 performs processing of storing information necessary for comparing the port configuration information with respect to an entry in which the opposing ID comparison C124/C224 is “non-coincidence” (step F154). Specifically, first, an entry of the port configuration information T30 including the same value as that stored in the port C121/C221 of the entry in the port C301 is searched, the value of the group ID C304 of the searched entry is stored in a port group ID C125/C225 of a target entry of the LLDP/FDB information (for comparison) T12/T22. Next, an entry including the same value as the opposing ID current value C123/C223 of the LLDP/FDB information (for comparison) T12/T22 in the opposing ID expected value C122/C222 is searched, and the value of the port C121/C221 of the searched entry is stored in a current value port C126/C226.

Finally, an entry of the port configuration information T30 including the same value as that of the current value port C126/C226 of the LLDP/FDB information (for comparison) T12/T22 in the port C301 is searched, and the value of the group ID C304 of the searched entry is stored in the section of a current value port group ID C127/C227 of the target entry of the LLDP/FDB information (for comparison) T12/T22.

Next, the comparison unit F20 compares the port group ID C125/C225 and the current value port group ID C127/C227 with respect to a port in which the opposing ID comparison C124/C224 of the LLDP/FDB information (for comparison) T12/T22 is “non-coincidence” (step F155).

As the result of the comparison, in a case where both of the port group ID values are identical to each other (YES of step 156), in processing F157, “coincidence” is stored in port group ID comparison C128/C228 (step F157), and the processing of F15 is ended. In a case where both of the port group ID values are not identical to each other (NO of step F156), “non-coincidence” is stored in the port group ID comparison C128/C228 (step F158), and the processing of F15 is ended.

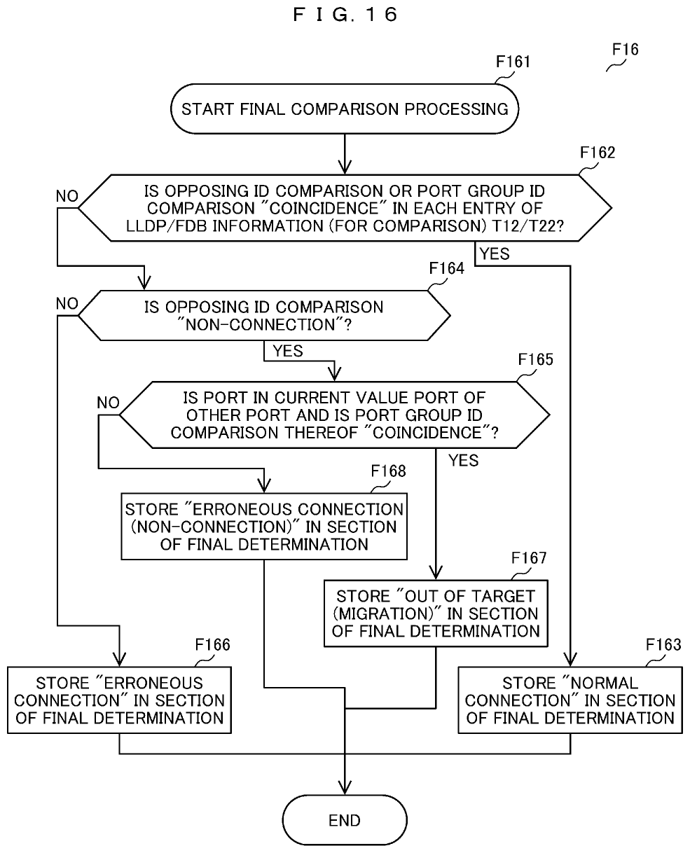

FIG. 16 is a flowchart illustrating the details of the comparison processing (step F16) that is determination processing of the final connection state. Note that, the processing of step F16 is executed with respect to each of the entries of the LLDP/FDB information (for comparison) T12/T22. In the following description, the content to be executed with respect to one target entry will be described.

After the processing is started, in a processing target entry of the LLDP/FDB information (for comparison) T12/T22, in a case where either the opposing ID comparison C124/C224 or the port group ID comparison C128/C228 is “coincidence” (YES of step F162), the comparison unit F20 called from the erroneous connection detection unit M10 stores “normal connection” in final determination C129/C229 (step F163), and ends the processing of F16.

In a case where either the opposing ID comparison C124/C224 or the port group ID comparison C128/C228 is not “coincidence” (NO of step F162), the process proceeds to step F164. Here, “normal connection” indicates a state in which the same device as that before the replacement is connected to a port indicated by an entry as a processing target after the replacement of the layer 2 switch S10, or a state in which a different device is connected to the port, but the device is a device connected to a port belonging to the same group ID as that before the replacement of the layer 2 switch S10, and thus, there is no problem in such connection.

Next, in a case where the opposing ID comparison C124/C224 of the processing target entry is not “non-connection” (NO of step F164), “erroneous connection” is stored in the final determination C129/C229 (step F166), and the processing of F16 is ended. In a case of “non-connection” (YES of step 164), the process proceeds to a branch F165.

Here, “erroneous connection” indicates a state in which a different device is connected to the port indicated by the entry as the processing target after the replacement of the layer 2 switch S10, and the device is a device connected to a port belonging to a different group ID from that before the replacement of the layer 2 switch S10, and thus, the device of which the connection to the port is not allowed is connected.

Next, it is examined whether or not the value of the port C121/C221 of the processing target entry is stored in the current value port C126/C127 of the other port, and in a case where the value is stored, the port group ID comparison C128/C228 of the port is “coincidence” (YES of step F165), and “out of target (migration)” is stored in the section of the final determination C129/C229, and the processing of F16 is ended (step F167). In a case where the value is not stored (NO of step F165), “erroneous connection (non-connection)” is stored in the section of the final determination C129/C229, and the processing of F16 is ended (step F168).

Here, “out of target (migration)” indicates a state in which nothing is connected to the port indicated by the entry as the processing target after the replacement of the layer 2 switch S10, but the device connected to the port before the replacement is reconnected to another port belonging to the same group ID, and thus, there is no problem. In addition, “erroneous connection (non-connection)” indicates a state in which nothing is connected to the port indicated by the entry as the processing target is not connected to after the replacement of the layer 2 switch S10 and the device connected to the port before the replacement is not connected to any other port.

According to a sequence of processings described above, the reconnection state of the cable after the replacement of the layer 2 switch S10, and among them, the presence or absence of an erroneous connection port to be subjected to reconnection is determined.

Returning to the flowchart of FIG. 12, the erroneous connection detection unit M10 notifies the presence or absence of the erroneous connection of the cable that is determined to the processing up to step F16 by the user I/F unit M20 (step F124). Specifically, the presence or absence of the erroneous connection of the final determination C129/C229 of the LLDP/FDB information (for comparison) T12/T22 is notified by means such as syslog/mail/Web-UI. The notified information, for example, is used for the administrator to perform the reconnection of the cable or the like, on the basis of the notification.

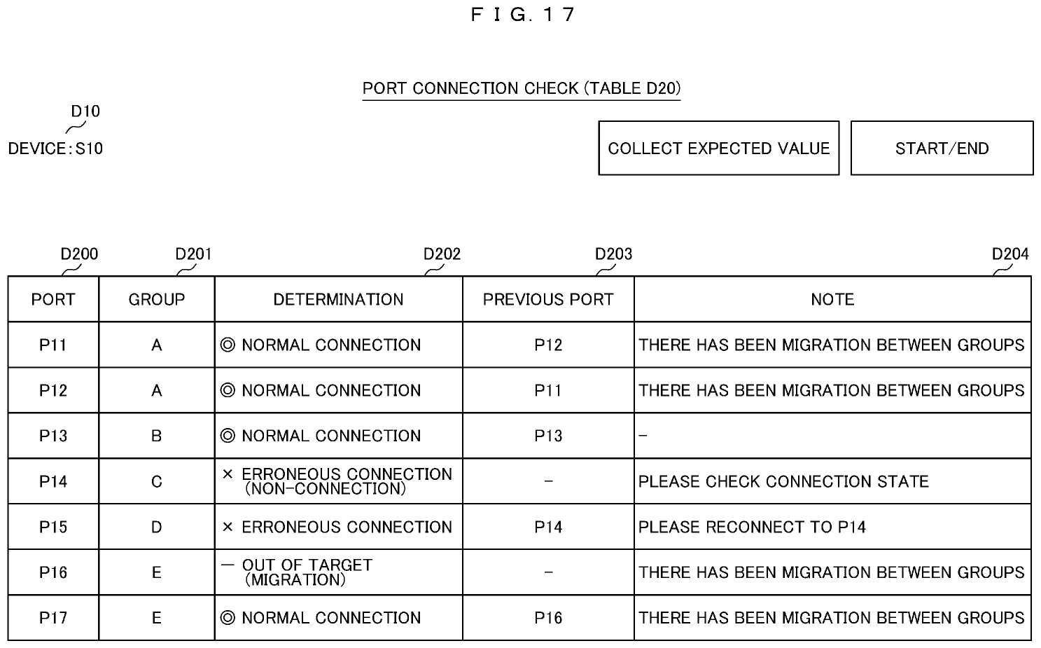

As an example of Web-UI, an example of a user I/F screen is illustrated in FIG. 17. A table D20 of a port connection check is displayed for the layer 2 switch S10 that is a target. In the table, the port of the port C120/C220 of the LLDP/FDB information (for comparison) T12/T22 is displayed in a port D200, the group ID of the group ID C304 of the port configuration information T30 is displayed in a group D201, the determination of the final determination C129/C229 is displayed in determination D202, the port of the port C120/C220 is displayed in a previous port D203 in a case where the opposing ID comparison C124/C224 of the LLDP/FDB information (for comparison) T12/T22 is “coincidence”, the port of the current value port C126/C226 is displayed in the previous port D203 in a case where the opposing ID comparison C124/C224 of the LLDP/FDB information (for comparison) T12/T22 is “non-coincidence”, and suitable description is displayed in D204, respectively.

After step F124, it is determined whether to continue or end the processing of determining the erroneous connection of the cable (step F125). Specifically, in a case where all of the sections of the final determination C129/C229 of the LLDP/FDB information (for comparison) T12/T22 are “normal connection” or “out of target (migration)” (indicating that the erroneous connection does not occur), or in a case where the user I/F unit M20 receives an end instruction from a user, the processing F12 is ended. Otherwise, in step F125, the process returns to the collection processing of the current value the opposing ID comparison processing F14, and repeats the processing.

Note that, in Example 1, the target is the layer 2 switch, but the same can also be applied to the layer 3 switch, a router, or the like. In this case, it can be easily conceived that ARP information or routing information can also be used as information indicating the connection state of the opposing terminal or the opposing device.

As described above, according to Example 1, when the replacement of the device such as the layer 2 switch is performed, the occurrence of the erroneous connection of the cable before and after the replacement can be detected. Further, by using the port configuration information of the layer 2 switch or the like together, the erroneous connection is determined as the normal connection insofar as there is no influence in the operation of the system, and thus, there is an effect that the cable reconnection operation of the erroneous connection can be minimized.

### Example 2

In Example 2, an example of detecting erroneous connection that causes actual damage by affecting communication while allowing a connection error with respect to ports with the same port configuration, which does not affect the communication, when the reconnection of a cable is performed by the replacement or the like of a layer 2 switch, with a configuration in which an erroneous connection detection unit is provided in the layer 2 switch, will be described.

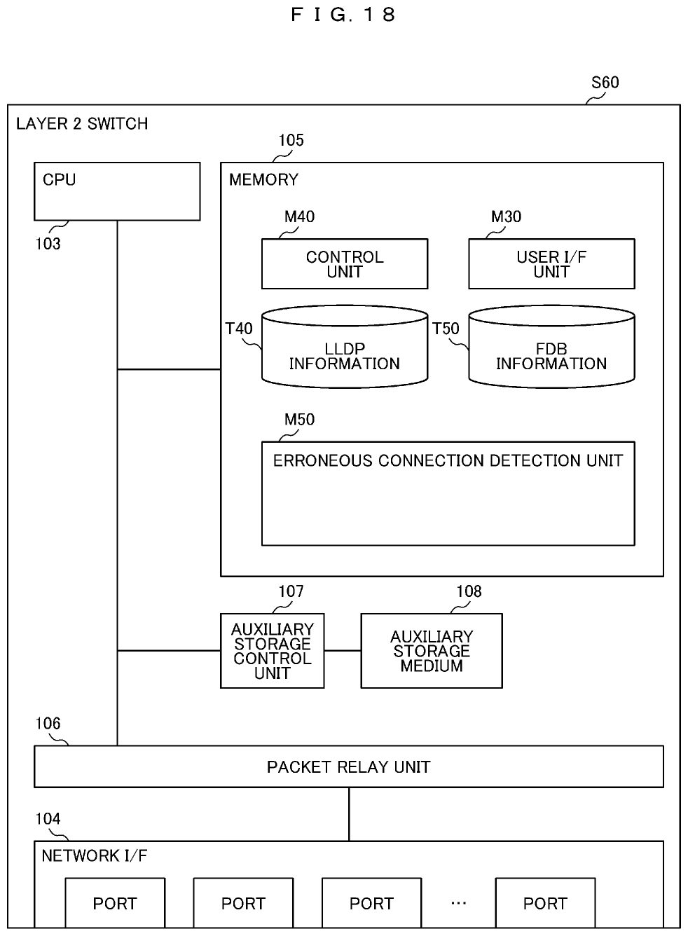

FIG. 18 is an explanatory diagram illustrating a configuration example of a layer 2 switch S60 in Example 2. Note that, the same reference numerals will be applied to the same constituents as those of the layer 2 switch S10 described in Example 1.

The configuration of the layer 2 switch S60 in FIG. 18 is a configuration in which an erroneous connection detection unit M50 that is approximately the same program as the erroneous connection detection unit M10 is stored in the memory 105 and is executed by the CPU 103, and is a configuration in which an auxiliary storage control unit 107 and an auxiliary storage medium 108 are further provided, compared to the layer 2 switch S10 described in Example 1.

The erroneous connection detection unit M50 includes the same processing units and the same tables as those of the erroneous connection detection unit M10 illustrated in FIG. 3. The illustration thereof will be omitted, and in the following description, the reference numerals illustrated in FIG. 3 will be used as reference.

The auxiliary storage medium 108 is a removable non-volatile storage medium, and the auxiliary storage control unit 107 controls read and write of data with respect to the auxiliary storage medium 108. When the layer 2 switch S60 is replaced with another device, the auxiliary storage medium 108 migrates information necessary for erroneous connection detection to the device after the replacement, and is premised on the fact that the device before the replacement can be replaced with the device after the replacement.

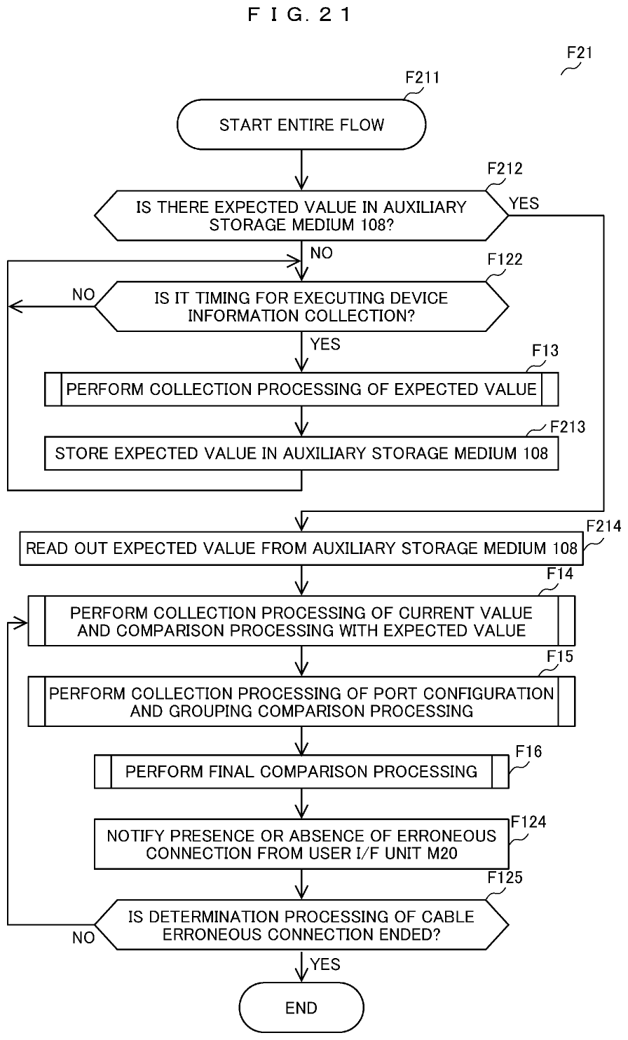

FIG. 21 is a flowchart illustrating the overall operation of the erroneous connection detection of the erroneous connection detection unit M50. Since such an operation is basically approximately the same as that of the processing in the flowchart of FIG. 12, described in Example 1, hereinafter, only differences from the flowchart of FIG. 12 will be described. In FIG. 21, the same reference numerals as those in FIG. 12 will be applied to the same processing as the processing in the flowchart of FIG. 12, and the detailed operation thereof will be omitted.

First, the erroneous connection detection unit M50 checks whether or not LLDP/FDB information is stored in the auxiliary storage medium 108, as the first step after the activation of the layer 2 switch S60, and in a case where the LLDP/FDB information is not stored, the process proceeds to the processing subsequent to step F122, and in a case where the LLDP/FDB information is stored, the process proceeds to the processing subsequent to step F214 (step F212). Such processing is processing for determining whether the current activation is reactivation after the replacement of the layer 2 switch S60 or the first activation after system construction, after the activation of the layer 2 switch S60. Using the presence or absence of the LLDP/FDB information in the auxiliary storage medium 108 for such determination is an example, and other operation identification information may be used for the determination by being stored in the auxiliary storage medium.

In a case where the LLDP/FDB information is not stored in the auxiliary storage medium 108 in step F212, the processing of step F122 and step F13 is executed. Such processing is basically the same as the processing described in the flowchart of FIG. 12. A difference is that in Example 1, the device information collection unit F10 collects the information from the layer 2 switch S10 by using a protocol such as SNMP, in step F13, whereas in Example 2, the information in the layer 2 switch S60 is directly referred to (the same is applied to the subsequent processing). Alternatively, in the layer 2 switch S60, the information may be acquired from the control unit M40 in local communication using a loopback interface by using SNMP or the like.

Next, the content of the LLDP/FDB information (the expected value) T10/T20 is stored in the auxiliary storage medium 108, and the process returns to step F122 (step F213). In a case where the LLDP/FDB information is stored in the auxiliary storage medium 108 in step F212, first, the LLDP/FDB information is read out from the auxiliary storage medium 108, and is stored in the LLDP/FDB information (the expected value) T10/T20 (step F214).

Next, the process proceeds to the processing subsequent to step F14, and detection processing of the erroneous connection is performed. Each processing subsequent to step F14 is the same as the processing described in the flowchart of FIG. 12.

According to the processing described above, erroneous connection detection is attained even by a single layer 2 switch S60. In a case where the erroneous connection detection unit M50 performs the erroneous connection detection of not only the own device but also the other layer 2 switch or the like, processing with respect to the other layer 2 switch or the like can be performed by the operation illustrated in the flowchart of FIG. 12.

Note that, in Example 2, the target is the layer 2 switch, but the same can be applied to a layer 3 switch, a router, or the like. In this case, it can be easily conceived that ARP information or routing information can also be used as information indicating the connection state of the opposing terminal or the opposing device.

According to Example 2, even in a small system in which it is difficult to prepare an erroneous connection detection device that is an external server device, there is an effect that the erroneous connection detection that allows the erroneous connection within a range not affecting the operation of the system can be performed by a single network device such as the layer 2 switch.

In Example described above, in a replacing operation of the network device, in a case where there is no influence on the communication or the like even at the time of performing the connection to any of the plurality of ports, there is flexibility that the connection to the port that is different from the previously connected port is not treated as the erroneous connection.

According to Example described above, in the replacing operation of the network device, the detection of the erroneous connection not affecting the operation of the network system can be suppressed. Accordingly, there is an effect that an unnecessary reconnection operation of a cable that is erroneously connected after the replacement of the network device is reduced, and the replacing operation is efficiently performed. In particular, in a switch on an access side to which a terminal is connected, there is a great effect since most of the ports generally allow the erroneous connection not affecting the operation.

### Example 3

In Example 3, a case in which there is a device in which connection information is not capable of being acquired or managed with respect to an opposing terminal or an opposing device by LLDP, such as a non-intelligent layer 2 switch or a repeater hub, with a configuration in which an erroneous connection detection unit is provided in a network management server as with Example 1 or in a layer 2 switch as with Example 2, will be described.

An example of detecting erroneous connection that causes actual damage by affecting communication while allowing a connection error with respect to ports with the same port configuration, which does not affect the communication, when the reconnection of a cable is performed by the replacement or the like of a layer 2 switch, and of further notifying a correct connection destination will be described.

In a case where a non-LLDP-compliant non-intelligent layer 2 switch, a repeater hub, or the like is provided between the layer 2 switch and the terminal, the layer 2 switch is not capable of recognizing the existence thereof by LLDP. Accordingly, even in a case where erroneous connection of the non-LLDP-compliant non-intelligent layer 2 switch, the repeater hub, or the like occurs due to reconnection by the replacement of the layer 2 switch, the erroneous connection is not capable of being directly detected. In Example 3, even in such a situation, the possibility of the erroneous connection can be estimated by using the information of a terminal that is connected to the tip of the non-LLDP-compliant switch, and can be notified to a network administrator.

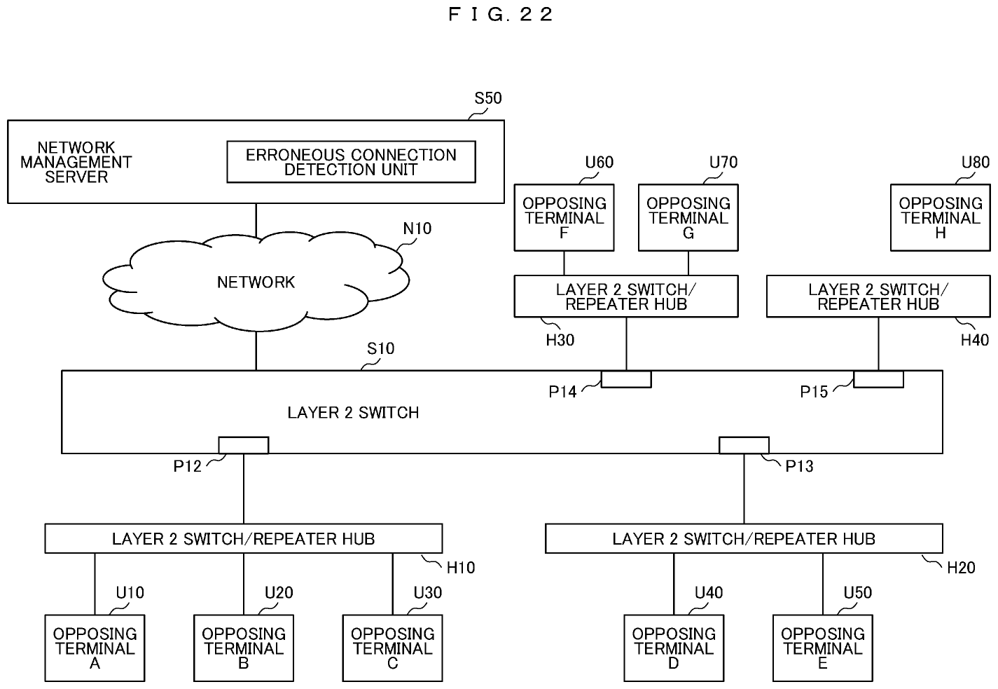

FIG. 22 is an explanatory diagram illustrating a configuration example of a network system in Example 3 of the invention. Note that, the same reference numerals will be applied to the same constituents as those in the configuration example of the network system described in Example 1 or Example 2.

In the network system of FIG. 22, the network management server S50 is connected to the layer 2 switch S10 to be a target for detecting the erroneous connection through the network N10. The layer 2 switch S10 includes the ports P12 to P15. The ports are connected by cables such as a copper wire or an optical fiber, respectively.

The port P12 is connected to the opposing terminal A(U10), the opposing terminal B(U20), and the opposing terminal C(U30) through the layer 2 switch or a repeater hub (H10). The port P13 is connected to an opposing terminal D(U40) and an opposing terminal E(U50) through the layer 2 switch or a repeater hub (H20). The port P14 is connected to an opposing terminal F(U60) and an opposing terminal G(U70) through the layer 2 switch or a repeater hub (H30). The port P15 is connected to an opposing terminal H(U80) through the layer 2 switch or a repeater hub (H40).

The configuration of the layer 2 switch S10 in Example 3 is the same configuration as that in Example 1 or Example 2, and thus, the description thereof will be omitted.

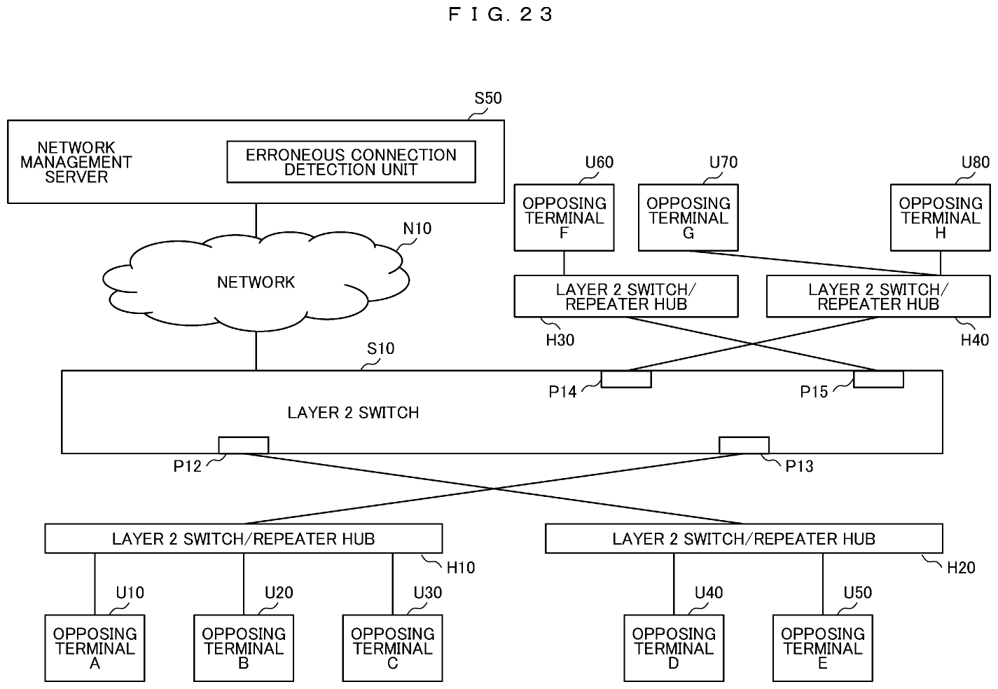

The configuration of a network in FIG. 23 represents that the replacement of the layer 2 switch S10 occurs in the configuration of FIG. 22, and the port P12 is connected to the layer 2 switch or the repeater hub (H20), the port P13 is connected to the layer 2 switch or the repeater hub (H10), the port P14 is connected to the layer 2 switch or the repeater hub (H40), and the port P15 is connected to the layer 2 switch or the repeater hub (H30), by a cable reconnection operation after the replacement.

In addition, it is represented that the opposing terminal G(U70) connected to the layer 2 switch or the repeater hub (H30) is migrated to the layer 2 switch or the repeater hub (H40). In such migration, a situation is assumed in which the opposing terminal G(U70) is reconnected to another layer 2 switch or repeater hub in the middle of a replacing operation of the layer 2 switch S10.

Communication disconnection occurs during the replacing operation of the layer 2 switch S10, and thus, for example, a possibility that a user using the terminal during the replacing operation tries to solve the disconnection by reconnecting the terminal to another layer 2 switch or repeater hub is considered.

An operation example of detecting the occurrence of the erroneous connection will be described below by using a case in which the erroneous connection as illustrated in FIG. 23 occurs from the system configuration in FIG. 22 by the reconnection operation after the replacement of the device, as an example.

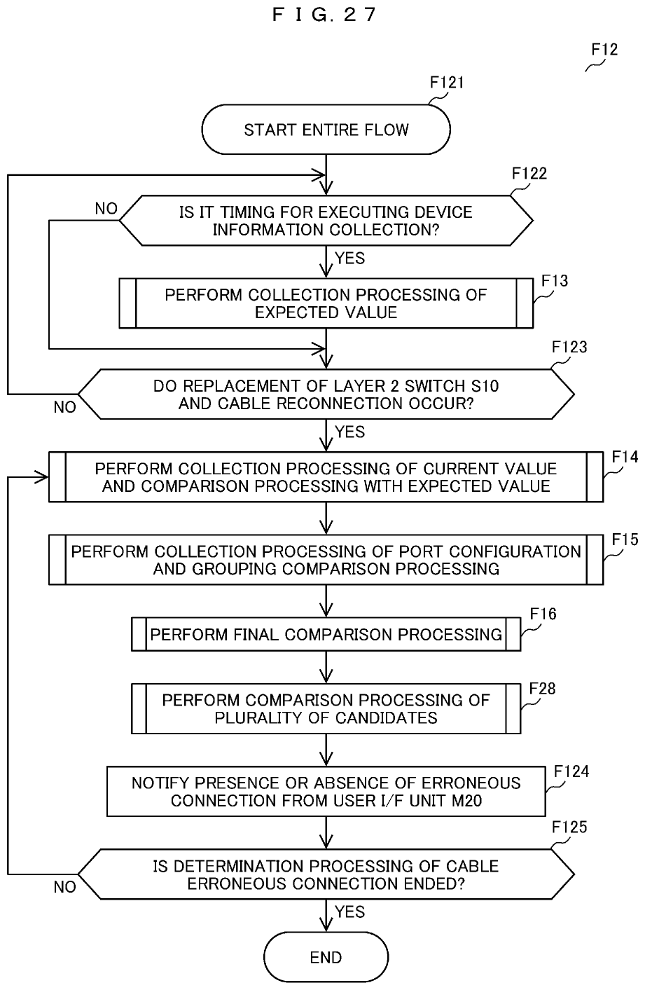

FIG. 27 is a flowchart illustrating the overall operation of the erroneous connection detection of the erroneous connection detection unit M10. Such an operation is basically approximately the same as that of the processing in the flowchart of FIG. 12, described in Example 1, except that step F28 is added between step F16 and step F124. Accordingly, hereinafter, only step F28 that is different from the flowchart in FIG. 12 will be described. In FIG. 27, the same reference numerals as those in FIG. 12 will be applied to the steps of performing the same processing as that in the flowchart of FIG. 12, and the description of the detailed operation thereof will be omitted.

Note that, each processing up to step F16 is the same processing as that described in the flowchart of FIG. 12 in Example 1, but in a case where it is seemed that a plurality of terminals are directly connected to the tip of one port of the layer 2 switch S10 through the layer 2 switch or the repeater hub, a plurality of opposing IDs (MAC addresses) are stored in the column of the opposing IDs of each of the tables of the FDB information (the expected value) T20, the FDB information (the current value) T21, and the FDB information (for comparison) T22. In this case, such a set is treated as the opposing ID.

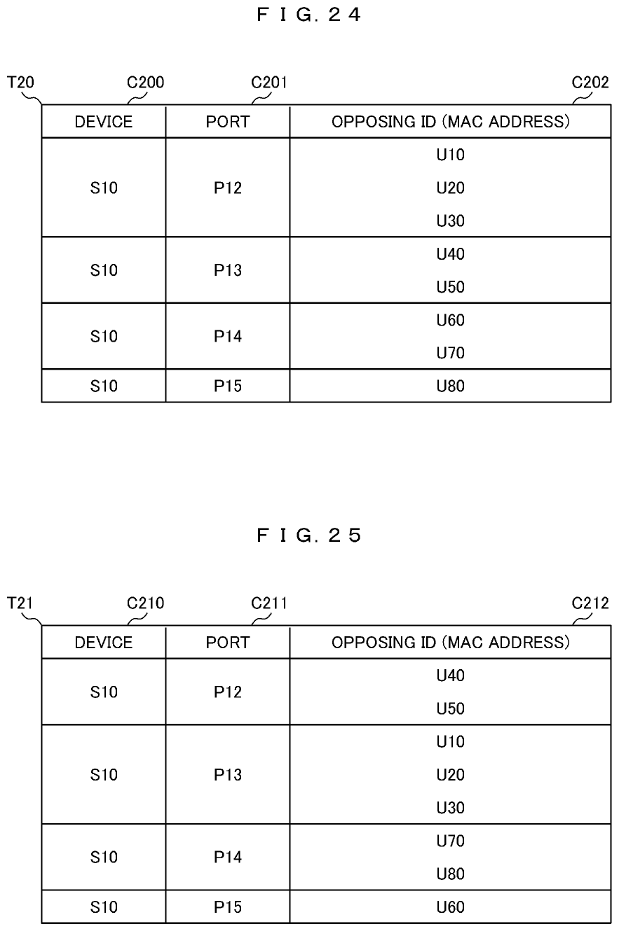

FIG. 24 is an example of the FDB information (the expected value) T20 including the information collected by step F13 before the replacement of the layer 2 switch S10 (the network configuration of FIG. 22).

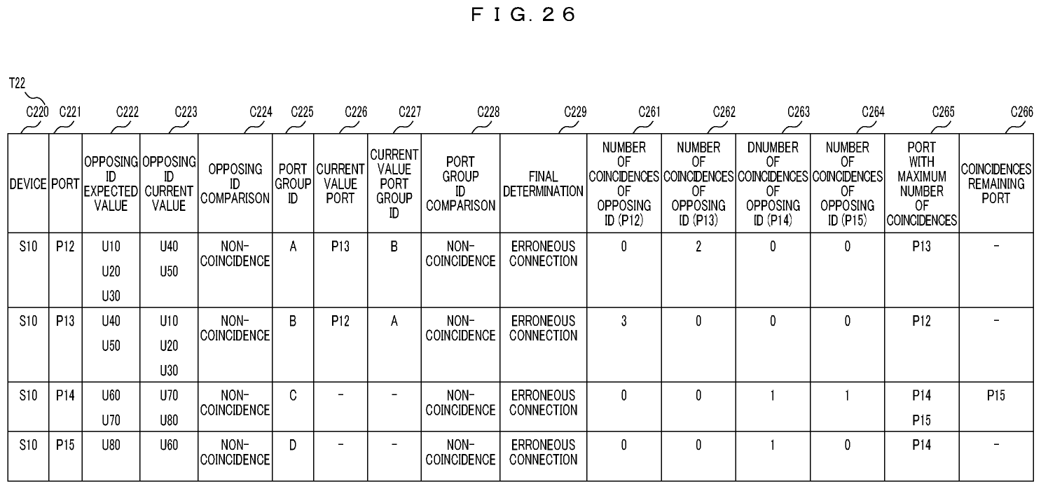

FIG. 25 is an example of the FDB information (the current value) T21 including the information collected by step F14 after the replacement of the layer 2 switch S10 (the network configuration of FIG. 23).

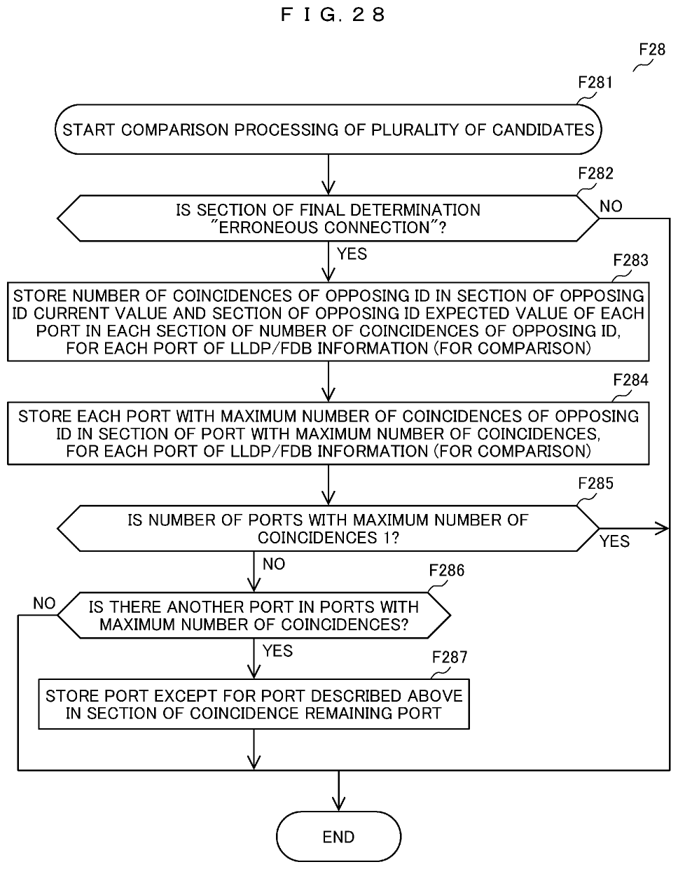

FIG. 28 is a flowchart illustrating the details of comparison processing (step F28) of a plurality of candidates, which is added in Example 3.

The processing of step F28 is executed with respect to each entry of FDB information (for comparison) T22 in FIG. 26. Note that, the FDB information (for comparison) in FIG. 26 is information in which the columns of C261 to C266 are added to the FDB information (for comparison) T22 in FIG. 10. In addition, the values of the columns of C220 to C229 of the FDB information (for comparison) T22 are stored in advance by the processing of steps F14 and F15 in the flowchart of FIG. 27 before step F28 is started. In the following description, the content to be executed with respect to one target entry will be described.

After the processing of step F28 is started, first, in the processing target entry of the FDB information (for comparison) T22, in a case where the final determination C229 is not “erroneous connection” (NO of step F282), the comparison unit F20 called from the erroneous connection detection unit M10 ends the processing of F28.

In a case where the final determination C229 is “erroneous connection” (YES of step F282), the process proceeds to step F283. Here, “erroneous connection” indicates a state in which a set of opposing IDs different from those before the replacement are connected to a port indicated by an entry as a processing target after the replacement of the layer 2 switch S10, and the set of the opposing IDs are a set of opposing IDs connected to a port belonging to a different group ID from that before the replacement of the layer 2 switch S10, and thus, there is no problem in such connection.

Next, in step F283, the number of opposing IDs in a set of the opposing ID current values C223 of the target entry, that are coincident with respect to a set of the opposing ID expected values C222 of each of the entries of the FDB information (for comparison) T22, is counted, and the number of opposing IDs is stored in the number C261 of coincidences of the opposing ID to the number C264 of coincidences of the opposing ID, corresponding to the port C221 of each of the entries, and the process proceeds to step F284.

In a case of describing a specific example in FIG. 26, for example, in the processing with respect to the first row (the port C221 is the entry of P12), the opposing ID expected value C222 of the first row is a set of “U10, U20, U30”, and the opposing ID current value C223 of the first row is a set of “U40, U50”, and thus, there is no element coincident with each other in both of the sets, and the number (P12) C261 of coincidences of the opposing ID of the first row is 0.

The opposing ID expected value C222 of the second row (the port C221 is the entry of P13) is a set of “U40, U50”, and the opposing ID current value C223 of the first row is a set of “U40, U50”, and thus, there are two elements coincident with each other in both of the sets, and the number (P13) C262 of coincidences of the opposing ID of the first row is 2. By repeating the same comparison processing, the values of the number (P14) C263 of coincidences of the opposing ID of the first row and the number (P15) C264 of coincidences of the opposing ID of the first row are 0, respectively.

Next, in step F284, a port with the maximum number of coincidences in the number C261 of coincidences of the opposing ID and the number C264 of coincidences of the opposing ID is stored in a port C265 with the maximum number of coincidences. In a case where there are a plurality of ports with the maximum number of coincidences, the plurality of ports are stored, and the process proceeds to step F285. For example, in the processing with respect to the first row (the port C221 is the row of P12), the maximum value in the number C261 of coincidences of the opposing ID to the number C264 of coincidences of the opposing ID is 2 that is stored in the number (P13) C262 of coincidences of the opposing ID, and thus, P13 is stored in the port C265 with the maximum number of coincidences.

In the processing with respect to the third row (the port C221 is the row of P14), the maximum value in the number C261 of coincidences of the opposing ID to the number C264 of coincidences of the opposing ID is 1 that is stored in the number (P14) C263 of coincidences of the opposing ID and the number (P15) C264 of coincidences of the opposing ID, and thus, P14 and P15 are stored in the port C265 with the maximum number of coincidences.

The processing from step F282 to step F284 described above is executed with respect to all of the entries of the FDB information (for comparison) T22, and then, the process proceeds to the processing subsequent to step F285.

Next, in step F285, in a case where the number of ports stored in the port C265 with the maximum number of coincidences is 1 (YES of step F285), the processing of F28 is ended.

In a case where there are a plurality of ports (NO of step F285), the process proceeds to step F286.

In step F286 and step F287, in a set of the ports stored in the port C265 with the maximum number of coincidences, a port except for the ports that are stored as a single port in the port C265 with the maximum number of coincidences of another entry of the FDB information (for comparison) T22 is stored in a coincidence remaining port C266.

In the example of FIG. 26, the third row (the port C221 is the entry of P14) includes a plurality of ports P14 and P15 in the port C265 with the maximum number of coincidences, and thus, is subjected to the processing of step F286, and among them, P14 is the fourth row (the port C221 is the entry of P15) and is stored as a single port in the port C265 with the maximum number of coincidences, and thus, is not subjected to the processing, and as a result thereof, in step F287, only P15 is stored in the coincidence remaining port C266 of the third row.

Returning to the flowchart of FIG. 27, the process proceeds to the processing subsequent to F124, and the detection processing of the erroneous connection is performed. Each processing subsequent to step F124 is the same as the processing described in the flowchart of FIG. 12.

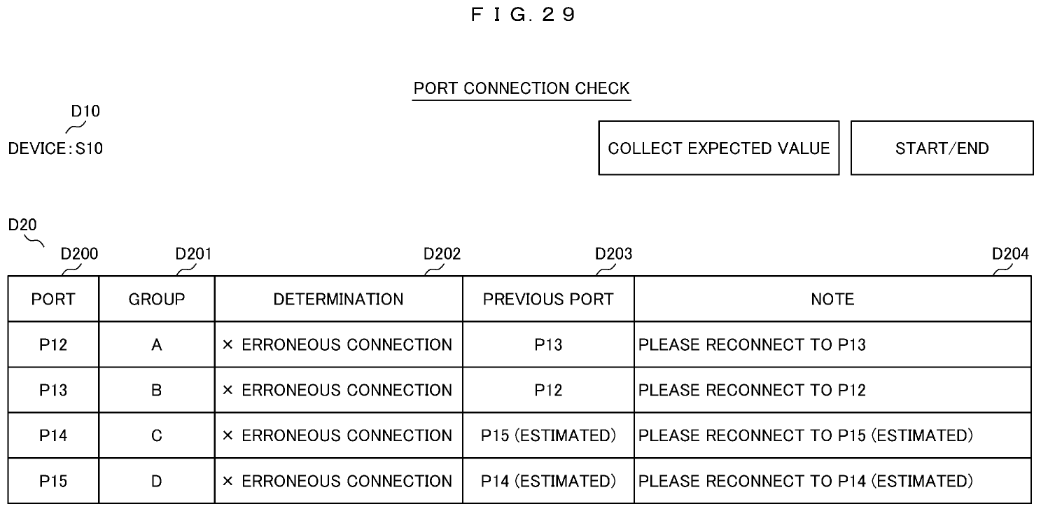

In Example 3, an example of a user I/F screen is illustrated in FIG. 29, as an example of Web-UI displaying a detection result of the erroneous connection.

The table D20 of the port connection check is displayed for the layer 2 switch S10 that is a target. Each row of the table D20 displays information corresponding to the content of each of the entries of the FDB information (for comparison) T22.

In each of the rows, the port of the port C221 of the FDB information (for comparison) T22 is displayed in the port D200 of the table. The group ID of a port group ID C225 of the FDB information (for comparison) T22 is displayed in the group D201. The determination of the final determination C229 is displayed in the determination D202.

In the previous port D203, in a case where the opposing ID comparison C224 of the FDB information (for comparison) T22 is “coincidence”, the port of the port C221 is displayed, and in a case where the opposing ID comparison C224 of the FDB information (for comparison) T22 is “non-coincidence”, and the number of ports of the port C265 with the maximum number of coincidences is 1, the port is displayed, and in a case where there are a plurality of ports of C265, the coincidence remaining port C266 is displayed. Suitable description is displayed in D204.

Here, in a case where the current value port C226 is vacant, the letter of “(estimated)” is further added to the end of the port of the previous port D203. This is because the fact that the current value port C226 is vacant indicates that at the time of obtaining the current value port C226 in step F154 (FIG. 15), an entry including a set of ports completely coincident with the opposing ID current value C223 in the opposing ID expected value C222 is not found, and the fact that the port displayed in the previous port D203 is an estimated value is notified to the network administrator.

In a case of describing the previous port D203 with an example of FIG. 26, in the port P12 of the device S10, C224 displays “non-coincidence”, the port stored in C265 displays one port of P13, and the value of C265 displays “P13” since C226 is not vacant. In the port P13 of the device S10, C224 displays “non-coincidence”, the port stored in C265 displays one port of P12, and the value of C265 displays “P12” since C226 is not vacant.

In the port P14 of the device S10, C224 displays “non-coincidence”, the port stored in C265 displays two ports of P14 and P15, and the value of C266 displays “P15 (estimated)” to which “(estimated)” is added since C226 is vacant. In the port P15 of device S10, C224 displays “non-coincidence”, the port stored in C265 displays one port of P14, and the value of C265 displays “P14 (estimated)” to which “(estimated)” is added since C226 is vacant.

Note that, in the network configuration of FIG. 22 and FIG. 23, described as Example 3, the opposing device to be connected to the layer 2 switch S10 (the layer 2 switch having a LLDP function, other than the layer 2 switch S10) does not exist, and thus, the description thereof is omitted, but in a case where the opposing device is also connected, a determination result based on the LLDP information (for comparison) T12 is also displayed in the table D20 by the same processing as that in a case of displaying a screen example of FIG. 17 in Example 1.

According to the processing described above, even in a case where there is a device that is not capable of acquiring the connection information with respect to the opposing terminal or the opposing device by LLDP, such as the non-intelligent layer 2 switch or the repeater hub, the erroneous connection detection is attained.

In Example described above, in the replacing operation of the network device, in a case where there is no influence on the communication or the like even at the time of performing the connection to any of the plurality of ports, there is flexibility that the connection to the port that is different from the previously connected port is not treated as the erroneous connection.

According to Example described above, in the replacing operation of the network device, the detection of the erroneous connection not affecting the operation of the network system can be suppressed. Accordingly, there is an effect that the unnecessary reconnection operation of the cable that is erroneously connected after the replacement of the network device is reduced, and the replacing operation is efficiently performed. In particular, in the switch on the access side to which the terminal is connected, there is a great effect since most of the ports generally allow the erroneous connection not affecting the operation.

According to Example described above, in the replacing operation of the network device, the detection of the erroneous connection is attained even in a case where there is the layer 2 switch that is not managed during the connection with respect to the opposing terminal or the opposing device. Accordingly, there is an effect that the unnecessary reconnection operation of the cable that is erroneously connected after the replacement of the network device is reduced, and the replacing operation is efficiently performed. In particular, in the switch on the access side to which the terminal is connected, there is a great effect since an inexpensive non-intelligent layer 2 switch is generally used regardless of a connection mode of the cable, and even in the replacement of the upper switch thereof, the detection of the erroneous connection is attained.

What is claimed is:

1. A network management server, comprising:
an erroneous connection detection unit connected to a network device including a plurality of ports connected to a plurality of opposing devices by cables through a network,
wherein the erroneous connection detection unit stores expected value information in which the plurality of ports and opposing identification information of the plurality of opposing devices are associated with each other in a state before replacement of the network device, current value information in which the plurality of ports and the opposing identification information of the plurality of opposing devices are associated with each other in a state after the replacement of the network device, and port configuration information in which the plurality of ports and group identification information grouped in accordance with a configuration of the port are associated with each other, and
when reconnection of the cable is performed by the replacement of the network device,
the erroneous connection detection unit compares the opposing identification information of the current value information and the opposing identification information of the expected value information,
compares the group identification information before the replacement of the network device and the group identification information after the replacement of the network device, with reference to the port configuration information, and
determines the presence or absence of erroneous connection of the cable, on the basis of a result of the comparison.

2. The network management server according to claim 1,
wherein the erroneous connection detection unit determines that connection of the cable is normal connection when the opposing identification information of the expected value information and the opposing identification information of the current value information are coincident with each other, as the result of the comparison.

3. The network management server according to claim 1,
wherein the erroneous connection detection unit determines that connection of the cable is normal connection when the opposing identification information of the expected value information and the opposing identification information of the current value information are not coincident with each other, and the group identification information before the replacement of the network device and the group identification information after the replacement of the network device are coincident with each other, as the result of the comparison.

4. The network management server according to claim 1,
wherein the erroneous connection detection unit determines that connection of the cable is erroneous connection when the opposing identification information of the expected value information and the opposing identification information of the current value information are not coincident with each other, and the group identification information before the replacement of the network device and the group identification information after the replacement of the network device are not coincident with each other, as the result of the comparison.

5. The network management server according to claim 1,
wherein the erroneous connection detection unit determines that the cable is not connected when the opposing identification information of the expected value information and the opposing identification information of the current value information are not coincident with each other, and the opposing identification information of the current value information does not exist, as the result of the comparison.

6. The network management server according to claim 1,
wherein the expected value information and the current value information are configured of FDB information and LLDP information, respectively.

7. The network management server according to claim 1, further comprising:
a user interface unit notifying the presence or absence of the erroneous connection of the cable.

8. A network device including a plurality of ports connected to a plurality of opposing devices by cables, the network device comprising:
an erroneous connection detection unit; and
a removable auxiliary storage medium,
wherein the auxiliary storage medium stores expected value information in which the plurality of ports and opposing identification information of the plurality of opposing devices are associated with each other in a state before replacement of the network device,
the erroneous connection detection unit stores current value information in which the plurality of ports and the opposing identification information of the plurality of opposing devices are associated with each other in a state after the replacement of the network device, and port configuration information in which the ports and group identification information grouped in accordance with a configuration of the port are associated with each other, and
when reconnection of the cable is performed by the replacement of the network device,
the auxiliary storage medium is replaced to the network device after the replacement from the network device before the replacement, and
the erroneous connection detection unit compares the opposing identification information of the current value information and the opposing identification information of the expected value information stored in the auxiliary storage medium,
compares the group identification information before the replacement of the network device and the group identification information after the replacement of the network device, with reference to the port configuration information, and
determines the presence or absence of erroneous connection of the cable, on the basis of a result of the comparison.

9. An erroneous connection detection program stored in a network management server connected to a network device including a plurality of ports connected to a plurality of opposing devices by cables through a network, the erroneous connection detection program configured to allow a computer:
to execute processing of storing expected value information in which the plurality of ports and opposing identification information of the plurality of opposing devices are associated with each other in a state before replacement of the network device, current value information in which the plurality of ports and the opposing identification information of the plurality of opposing devices are associated with each other in a state after the replacement of the network device, and port configuration information in which the plurality of ports and group identification information grouped in accordance with a configuration of the port are associated with each other; and
when reconnection of the cable is performed by the replacement of the network device,
to execute processing of comparing the opposing identification information of the current value information and the opposing identification information of the expected value information;
processing of comparing the group identification information before the replacement of the network device and the group identification information after the replacement of the network device, with reference to the port configuration information; and
processing of determining the presence or absence of erroneous connection of the cable, on the basis of a result of the comparison.

10. The erroneous connection detection program according to claim 9,
wherein it is determined that connection of the cable is normal connection when the opposing identification information of the expected value information and the opposing identification information of the current value information are coincident with each other, as the result of the comparison.

11. The erroneous connection detection program according to claim 9,
wherein it is determined that connection of the cable is normal connection when the opposing identification information of the expected value information and the opposing identification information of the current value information are not coincident with each other, and the group identification information before the replacement of the network device and the group identification information after the replacement of the network device are coincident with each other, as the result of the comparison.

12. The erroneous connection detection program according to claim 9,
wherein it is determined that connection of the cable is erroneous connection when the opposing identification information of the expected value information and the opposing identification information of the current value information are not coincident with each other, and the group identification information before the replacement of the network device and the group identification information after the replacement of the network device are not coincident with each other, as the result of the comparison.

13. The erroneous connection detection program according to claim 9,
wherein it is determined that the cable is not connected when the opposing identification information of the expected value information and the opposing identification information of the current value information are not coincident with each other, and the opposing identification information of the current value information does not exist, as the result of the comparison.

14. The erroneous connection detection program according to claim 9,
wherein the expected value information and the current value information are configured of FDB information and LLDP information, respectively.

15. The erroneous connection detection program according to claim 9, further allowing the computer:
to execute processing of notifying the presence or absence of the erroneous connection of the cable.

16. The network management server according to claim 1,
wherein at least one of the plurality of ports is connected to the plurality of opposing devices by the cable through another network device, and
when the reconnection of the cable is performed by the replacement of the network device,
the erroneous connection detection unit compares a set of the opposing identification information of the current value information and a set of the opposing identification information of the expected value information, and
determines the presence or absence of the erroneous connection of the cable, on the basis of a result of the comparison.

17. The network management server according to claim 16,
wherein when comparing the set of the opposing identification information of the current value information and the set of the opposing identification information of the expected value information,
the erroneous connection detection unit counts the number of coincidences of the opposing identification information of the expected value information for each of the ports,
estimates a port with the maximum number of coincidences, which is not selected by another port, as a correct port, and
determines the presence or absence of the erroneous connection of the cable, on the basis of the result of the comparison.

18. The erroneous connection detection program according to claim 9,
wherein at least one of the plurality of ports is connected to the plurality of opposing devices by the cable through another network device, and
when the reconnection of the cable is performed by the replacement of the network device,
a set of the opposing identification information of the current value information and a set of the opposing identification information of the expected value information are compared, and
the presence or absence of the erroneous connection of the cable is determined on the basis of a result of the comparison.

19. The erroneous connection detection program according to claim 18,
wherein when the set of the opposing identification information of the current value information and the set of the opposing identification information of the expected value information are compared,
the number of coincidences of the opposing identification information of the expected value information is counted for each of the ports,
a port with the maximum number of coincidences, which is not selected by another port, is estimated as a correct port, and
the presence or absence of the erroneous connection of the cable is determined on the basis of the result of the comparison.
